(19) United States
(12) Patent Application Publication
(10) Pub. No.: US 2018/0357715 A1
(43) Pub. Date: Dec. 13, 2018

(54) System and Method For a Virtual Currency Exchange

(71) Applicant: Rodriguez F. Jones, San Francisco, CA (US)

(72) Inventor: Rodriguez F. Jones, San Francisco, CA (US)

(21) Appl. No.: 15/972,875

(22) Filed: May 7, 2018

Related U.S. Application Data
(60) Provisional application No. 62/603,824, filed on Jun. 12, 2017.

(51) Int. Cl. G06Q 40/04; G06Q 20/06; G06Q 20/10; G06Q 20/36; G06Q 20/40

(52) U.S. Cl. CPC G06Q 40/04; G06Q 20/065; G06Q 20/4014; G06Q 20/36; G06Q 20/10

(57) ABSTRACT

Embodiments are described for a virtual currency exchange system having a network connecting a plurality of users. Each user may create a profile and engage with one another to send, receive, and trade for goods and services using a plurality of currencies.

### CROSS REFERENCE TO RELATED APPLICATIONS

This applications claims priority to U.S. Provisional Application 62/603,824 filed Jun. 21, 2017 which is hereby incorporated by reference.

### FIELD

The present invention relates to the field of monetary exchange methods and systems, and more specifically to the field of a virtual platform-mediated monetary exchange.

### BACKGROUND

In recent years, the proliferation of the internet has encroached in almost every sector of life and business. Computers, and other forms of personal electronic devices have greatly expanded in their role as a medium for commercial and personal transactions. This influx of computer implemented transactions has led to a corresponding influx in technologies facilitating these transactions. Many of these technologies operate by creating a digital analog of traditional currencies such as the U.S. Dollar, or likewise currencies. Contrarily, other digital payment methods permit “e-currencies” and thus have created a new digital store-of-value. These new digital stores of value operate by similar means as physical stores of value. Just as one trades a form of physical value to another for, what is hopefully, an equivalent transfer of value over mediums, one may trade e-currencies in a similar manner.

A form of e-currency that has expanded just recently is the bitcoin (“BTC”). Bitcoins are a specific form of internet cryptocurrency. They are intangible and exist in the virtual world in the form of a cryptic file which is stored on a personal electronic device, or other form of computer. Interestingly, bitcoin is a complete peer-to-peer system that does not rely and is not regulated by any form of government body. In this manner, bitcoin, and other forms of currency like it, are free of intergovernmental and inter banking systems that plague the industry today. Bitcoin allows for a company in Bangladesh to instantly transfer moneys, in this case bitcoin, to anyone, anywhere in the world in an instant manner. Doing this using the traditional banking system may take weeks, and in the end, no moneys may be transferred at all, leaving a service provider out of time and money spent.

It is becoming readily more apparent that transactions conducted electronically are forming an increasingly more important subset of the total transactions performed in the world.

These electronic transactions pose unique challenges such as the use of counterfeit money, counterfeit goods, or in other ways fraudulent services. Security of the system is of utmost concern and to mitigate the risks, a number of techniques have been devised. Commonly, techniques such as reciprocal and non reciprocal encryption are used. These use algorithms for encryption and decryption as well as keys used by the algorithm.

Many businesses have realized the value in virtual currencies as they promote and motivate customers to increase their loyalty to their brand. As virtual currency to the specific business is stored and increased, customers have been shown to increase their loyalty to the company. This has been seen in online marketplaces, where “awards points” may be earned, as well as in gaming settings where common currencies are earned and used.

Social media websites have been a source of impetus for business gains. Many companies have multiple social media accounts where they can post goods and services. Liking, or sharing the post in-turn results in the post to be seen my more people, increasing the advertising power of the post. To date, liking or sharing does not have a direct correlation to monetary gain for the user who liked or shared the post, providing little incentive to do so. It may be valuable for a business to monetize and thus promote liking and sharing of information in order to expand the companies marketing reach across the network.

It can be seen that there is an ever present need for the advancement of digital currency systems and methods for which consumers may electronically transfer funds for goods and services.

### SUMMARY OF THE INVENTION

Embodiments described herein provide for a system and method for a virtual currency exchange. The system is intended to be utilized in conjunction with a social media or network-based profile wherein users may interact with one another both socially and economically. Each user may create a profile that is uniquely their own. Any amount and form of currency may be submitted and converted to a virtual currency which is accounted for as a credit. At any time, the credit may be redeemed for another form of currency at the current trading value between the two currencies.

In an embodiment, a computer based system for virtual currency exchange has a network interface communicating with a memory. A processor is in communication with the memory such that the processor is configured to perform a plurality of steps including: storing an account for each of at least two users; generating a virtual storage component; accessing the virtual storage component; accessing a financial institution storage component; creating requests for currency, wherein each request creates a predetermined number of credits; transferring currency from the financial institution storage component to the virtual storage component as one or more credits; storing the one or more credits in the virtual storage component; receiving a plurality of requests from a first user to transfer credits to a second user; and transferring credits based on the request from the first user.

Users may engage in a marketplace environment. Vendors may include private or administrator-moderated entities who may engage in commerce or in social interactions with one another. Each event performed in the network may be provided a credit value. Upon the executing for the action, credits may be given to the executor to promote useful engagement throughout the network.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a block diagram of the network architecture, according to an embodiment of the present disclosure;

FIG. 2 illustrates a block diagram of the server and modules, according to an embodiment of the present invention; and

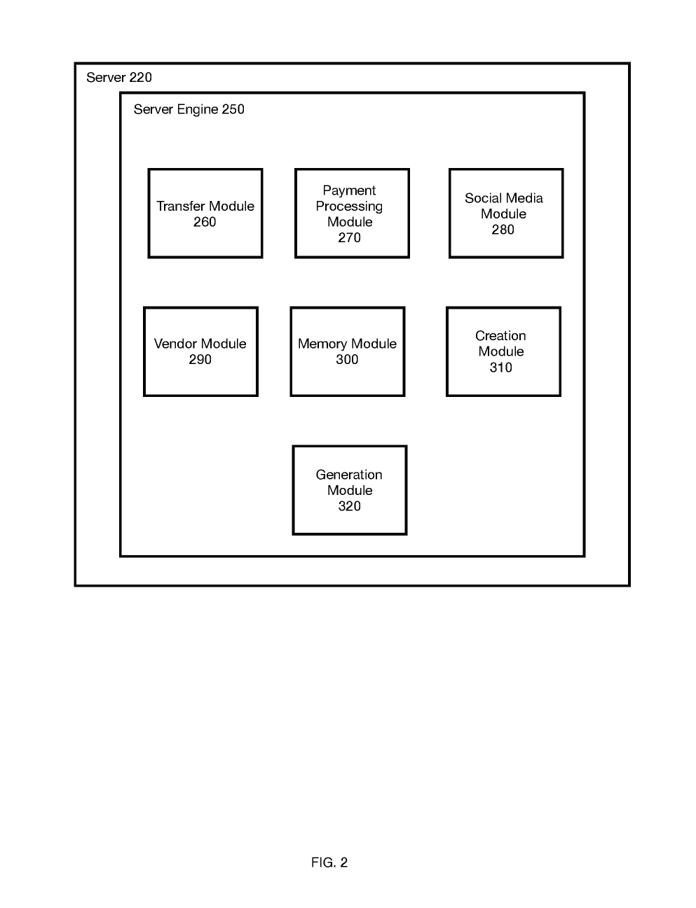

FIG. 3 illustrates a flow chart of a method for virtual currency exchange, according to an embodiment of the present invention.

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantage's” provided by some embodiments, other embodiments may not include those same advantages, or may include different advantages. Any advantages described herein are not to be construed as limiting to any of the claims.

Before describing in detail exemplary embodiments, it is noted that the embodiments reside primarily in combinations of components related to the system. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

In general, the virtual currency exchange system and method disclosed herein permits participants to exchange goods and services in a virtual environment. The instant system discloses a means by which users access to goods and services to a wide bank of participants from anywhere that internet access is permitted and available. For clarity, the term tangible currency refers to money available through government mediated means, such as the U.S. Dollar, while virtual currency refers to intangible currency available only currency used for transactions in the virtual environment.

The present exemplary embodiments are described herein with reference to system architecture, block diagrams and flowchart illustrations of methods, and computer program products according to various aspects of the disclosure. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, hypertexts, hyperlinks, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Participants of the virtual monetary exchange system may include, users, vendors, administrators, third party payers, storage entities, among other entities know and commonly associated with the arts. Each of the entities and users are in digital communication with one another through a network as known in the art. Typically, users may be defined as individuals whom exchange virtual currencies for a good, service, or as an investment vehicle to gain or lose virtual currencies. A vendor may be an individual or group of individuals who accept the virtual currency for a good or service rendered. An administrator controls the creation and exchange of currencies throughout the system. Further, the administrator may act as a user or vendor.

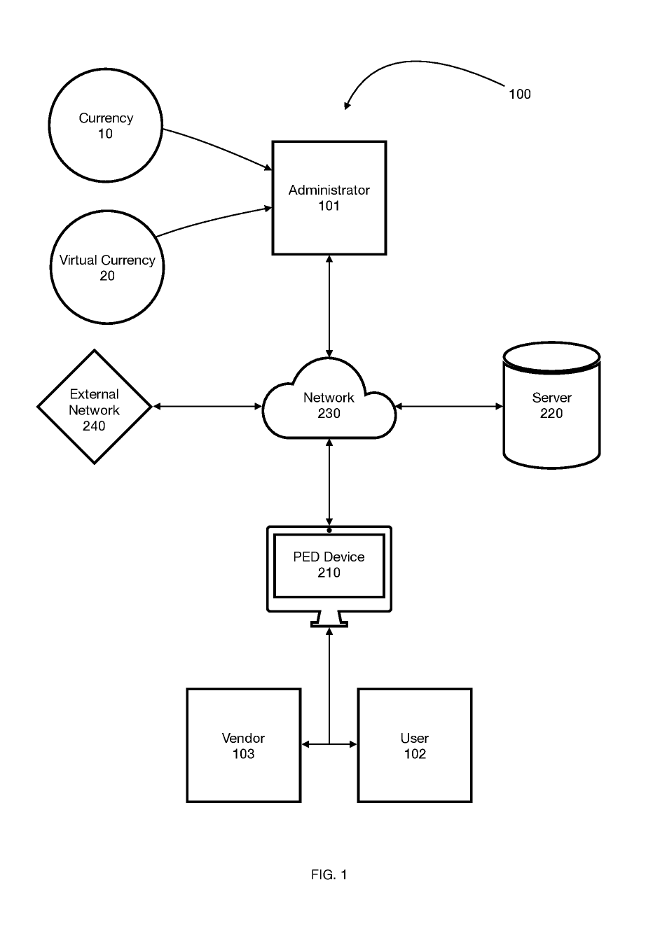

In specific reference to FIG. 1, a diagram of the interaction between each entity within the system is shown in an embodiment of the present disclosure. An administrator 101 may intake real currency 10 or virtual currency 20 in order to issue any number of credits 20, with credits being the virtual currency 20. Each may credit correspond to a specific value determined by a rate of exchange to real money, or each credit may correspond to an action performed in the virtual environment. The user 102 may then receive credits based on an action performed in the virtual environment, or they may purchase credits using real money, or as an investment with exist credits. The user 102 may then exchange credits with a vendor, or second user 103 or with the administrator 101 in return for goods or services, whether tangible or intangible. In turn, the vendor may accept and store credits, or redeem credits for real money.

In an embodiment, the system may be used to connect with a preexisting social media account such as Facebook and Instagram. An input into the social media account may correspond to a credit value predetermined by the administrator. In an example, a user completes an action, such as liking and sharing a post on Facebook and the overall number of likes, overall reach (amount of users who viewed the like or share) are tracked. The number of reach, likes and shares corresponding to the users like and share will correspond to a specific number of credits gained from the action.

In an alternate embodiment, a third party, such as an advertiser, a mobile phone carrier, a bank, or other form of operator may have access to transfer virtual or real currencies to influence the system. For example, a third party administrator may represent a monthly membership service whom may deduct credits each month for a service performed. The third party may then redeem the credits deducted with the administrator 101 in order to receive real money.

Plurality of Membership Accounts, Transfer “Points” Between the System and at Least One Program

In an embodiment of the present invention the virtual currency environment 200 is able to account for, redeem, create, and transfer virtual currency as well as additional information securely throughout the system. The environment 200 may contain one or more user devices 210, which may be defined as a computer, cell phone, or other personal electronic device which may send and receive data through the network. Further the environment 200 may contain one or more servers 220, a network 230, and a plurality of external networks 240. Communication between the networks may occur via wired or wireless communication networks. The server 220 may be accessed through one or more websites, such as a social network site.

In an embodiment, the one or more servers 220 having a server engine 250 may create, distribute, transform, or receive credits with identifying values and attributes as predetermined by an algorithm. In an embodiment, the server may be in communication with a credit storage component, such as a “credit wallet” wherein user credits are stored. Credits may be transferred into and out of the credit storage component using a transfer module 260. Each credit storage component may be identified by an identification tag, in order to identify the credit storage component as belonging to a specific user, administrator, or vendor.

In an embodiment, a creation module 310 may be used to create credits and input credits to the system for use and transfer. A payment processing module 270 may direct the processing of payments into and out of the system. This may include payments processed by users and vendors of the system, as well as external entities such as financial institutions. A memory module 300 saves data for recollection by the server 220.

A Social media module 280 performs necessary tasks to create, manage and engage with a social media profile. Likewise, a vendor module 290 interacts with the vendor and effects thereof. The generation module 320 permits the creation of content by any user in the system.

In an embodiment, a method for a virtual monetary exchange may include the steps of first, a user creating a profile for which the virtual currency will reside. This may include creating a digital credit storage component unique to the specific user. Each account for each user within the system is stored such that each account is in virtual communication with one another throughout the system. A plurality of requests may then be received to create new credits for the virtual environment. Each credit is recorded and stored by a data storage component belonging to a user, administrator, or vendor. The credit may correspond to a value in both real and virtual currencies and may fluctuate over time. A plurality of requests to transfer credits may be received between at least two accounts within the network. Each request may involve deducting credits from a user, and adding a corresponding amount of credits to a receiving user. Deductions may occur over the course of process, such as those for network fees, taxes, and others known in the art.

In an alternate embodiment, a plurality of requests may be made to redeem credits for a good or service.

In an embodiment, a social media actions is performed by a first user, for example, a Facebook post is liked. The network tracks the number of likes stemming from the first users action, the tracked number may be referred to as a tracking value. The tracking value is corresponded to a value of credits, which are then received from the administrator, vendor, or user. Further, a third party may engage with the process, allowing for users to engage in an action, a tracking event to occur, and transfer credits accordingly.

Preferentially, the system utilizes a dedicated and centralized banking system unlike other forms of virtual or cryptocurrencies which have a decentralized system. The system will operate on a dedicated social media platform.

Currency, whether physical or virtual, may be traded via a plurality of network-connected (e.g. online) storefronts selling goods. This increases user involvement, time spent within the network, and promotes connectivity thereto. Each storefront may be defined as a hierarchical store or independent store. A hierarchical store may be defined as a store owned or operated by the system administrator or managing body thereof. Each transaction made at a hierarchical store will result in a percentage of the profits realized by the administrator. Independent stores are not directly apart of the hierarchical stores as they are not organized into a group of the system administrator. These independent stores will generate their own traffic and will not rely on the system via marketing techniques known in the arts.

Similar to an actual bank, the system will manage funds using a fractional reserve system with the funds. The system will receive currency from its users via: 1. the funds transfer system; and 2. the currency converter. In a preferred embodiment, the currency converter permits users to make purchased within the network marketplace.

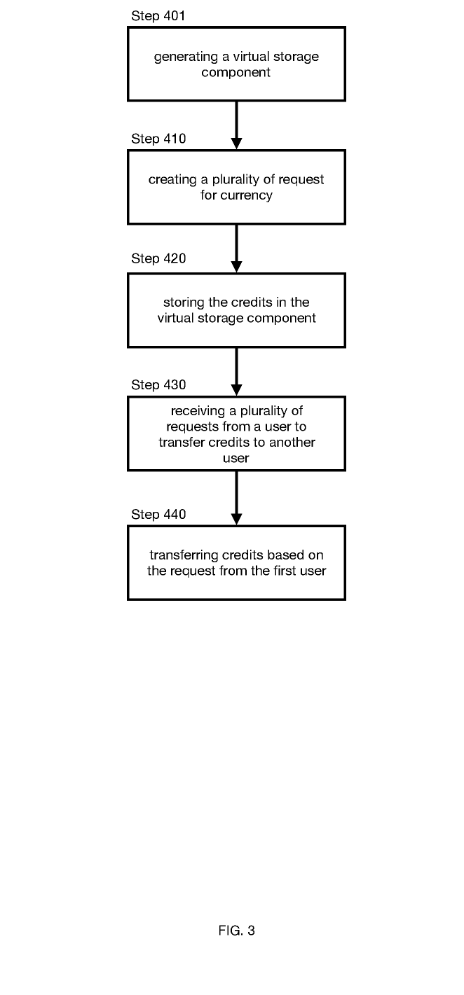

In reference to FIG. 3, step 401 relates to a user generating a virtual storage component followed by creating a plurality of requests for currency (currency may also be referred to as credits) in step 410. In step 420, credits are stored in the virtual storage component for later use by the user as described above. In step 430, a plurality of requests are received from a user to transfer credits to another user. This may be simply by request, or for the purchase and sale of a good or service. In step 440, credits are transferred based on the request from the user.

In yet another embodiment, another series of steps are presented for a method of virtual currency exchange. Step 601 includes presenting an advertisement for currency transfer to a user. This may follow a search for relevant terms wherein a pay-per-click or other advertisement system is employed. In step 610, the user configures an account with the system followed by connecting an external account. The external account may include any social media or online account. In step 620, the user is displayed advertising based on their connected account or similar data reserves. In step 630, currency is transferred to the system followed by the conversion of the currency into a virtual currency. In step 640, the system confirms the transfer and conversion of the currency by alerting the user. In optional step 650, the user receives an email notification with a link to redeem the transfer and are directed to the main webpage. In step 660, the user is prompted to connect an external account, such as Facebook or another online account managed by the user. Once connected, the transferred virtual currency is received in the main account of the user. The user now has two options, in step 670, the user may extract or convert their virtual currency back into a currency of their choice, such as a Dollar, or in step 675, they may spend the virtual currency in the marketplace. The user receiving the funds for a good or service will also be given the options in steps 670 and 675.

The commerce system may include an inventory of points, credits, or similar implement which are tracked and recorded for each user. Further an exchange rate calculator may be utilized to calculate the exchange rates between a plurality of currencies supported and utilized by the community of users. A currency conversion portal may be utilized where users can make payments using existing payment methods known in the arts including credit and debit cards, paypal, or alternate forms of currency and payment processing. These payments are then transferred to the system's own business bank account. Each user will then receive the appropriate amount of credits/points in their user account. This process is able to operate in a reverse order such that each user may redeem credits/points in exchange for another currency of their choice (i.e. the Dollar) which will then be transferred to their bank account. The user is further provided with a means for performing transactions between other users, permitting each and any user to transfer virtual currency to another user.

In an embodiment, the system permits each user to create a profile for themselves or their business. This profile permits the user to access the database, resources, and purchase products and services throughout the network. User's may network with each other, share advice, blogs, or otherwise engage with the community of users. Membership usage may be tracked as well as traffic flow and other metrics commonly used in the arts. A membership fee may accompany the profile of instructed by the user.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. One or more computer storage hardware devices storing computer-usable instructions that, when used by one or more computing devices, cause the one or more computing devices to perform a method within a system, the method comprising the steps of:
a. storing an account for each of a plurality of users;
b. generating a unique virtual storage component for each user;
c. creating requests for currency, wherein each request creates a predetermined number of credits
d. storing credits in the virtual wallet;
e. receiving a plurality of requests from a first user to transfer credits to a second user; and
f. transferring credits based on the request from the first user,
wherein the first user performs an action on a social media network, wherein the action is tracked to result in a value, wherein the value corresponds to a value of credit, and wherein the credit is transferred from the second user to the first user.

2. The method of claim 1, wherein the virtual wallet is a trust entity configured to entrust the credits.

3. The method of claim 1, wherein the platform includes an interface for a product or service transaction between the at least two users.

4. The method of claim 1, wherein the platform includes an interface for a financial transaction in real currency between one of the at least two users and a financial company.

5. The method of claim 1, wherein the at least two users interact over a graphical user interface.

6. The method of claim 1, wherein each user has an identifier, wherein the identifier is configured to validate the user.

7. A system for virtual currency exchange comprising:
a. a platform for a transaction between at least two users;
b. a processor configured to perform the following steps;
i. generating a virtual storage component;
ii. creating a plurality of requests for currency, wherein each request creates a predetermined number of a credit;
iii. storing the credits in the virtual storage component;
iv. receiving a plurality of requests from a first user to transfer credits to a second user; and
v. transferring credits based on the request from the first user,
wherein the processor generates an amount of virtual currency in response to an amount of real currency submitted by the user.

8. The system of claim 7, wherein the virtual storage component is a trust entity configured to entrust credits.

9. The system of claim 7, wherein the platform includes an interface for a product or service transaction between the at least two users.

10. The system of claim 7, wherein the platform includes an interface for a financial transaction in real currency between one of the at least two users and a financial company.

11. The system of claim 7, wherein the at least two users interact over a graphical user interface.

12. The method of claim 7, wherein each user has an identifier, wherein the identifier is configured to validate the user.

13. The system of claim 7, further comprising the steps of:
a. identifying, via the processor, a vendor for shopping by at least one user;
b. retrieving, via the processor, a stored value for a good or service to exchange for a plurality of credits from the at least one user;
c. receiving, via the at least one user, the good or service; and
d. converting, via the vendor utilizing the processor, the plurality of credits to a currency.

14. A computer based system for virtual currency exchange comprising:
a. a network interface communicating with a memory;
b. a processor in communication with the memory, wherein the processor is configured to perform the following:
i. storing an account for each of at least two users;
ii. generating a virtual storage component;
iii. accessing the virtual storage component;
iv. accessing a financial institution storage component;
v. creating requests for currency, wherein each request creates a predetermined number of credits;
vi. transferring currency from the financial institution storage component to the virtual storage component as one or more credits;
vii. storing the one or more credits in the virtual storage component;
viii. receiving a plurality of requests from a first user to transfer credits to a second user; and
ix. transferring credits based on the request from the first user,
wherein the first user performs an action on a social media network, wherein the action is tracked to result in a value, wherein the value corresponds to a value of credit, and wherein the credit is transferred from the second user to the first user.

15. The system of claim 14, wherein the virtual storage component is a trust entity configured to entrust the credits.

16. The system of claim 14, wherein the platform includes an interface for a product or service transaction between the at least two users.

17. The system of claim 14, wherein the platform includes an interface for a financial transaction in real currency between one of the at least two users and a financial company.

18. The system of claim 14, wherein the at least two users interact over a graphical user interface.

19. The system of claim 14, further comprising the steps of:
a. identifying, via the processor, a vendor for shopping by at least one user;
b. retrieving, via the processor, a stored value for a good or service to exchange for a plurality of credits from the at least one user;
c. receiving, via the at least one user, the good or service; and
d. converting, via the vendor utilizing the processor, the plurality of credits to a currency.

20. The method of claim 19, wherein each user has an identifier, wherein the identifier is configured to validate the user.
